(19) United States
(12) Patent Application Publication
(10) Pub. No.: US 2003/0168428 A1
(43) Pub. Date: Sep. 11, 2003

(54) Method for producing original record of optical recording medium

(76) Inventor: Akira Kouchiyama, Kanagawa (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 10/257,727

(22) PCT Filed: Feb. 18, 2002
(86) PCT No.: PCT/JP02/01373

(30) Foreign Application Priority Data
Feb. 21, 2001 (JP) 2001-45692

(51) Int. Cl. B44C 1/22; B29D 11/00

(52) U.S. Cl. 216/24; 216/22

(57) ABSTRACT

In this invention, in forming uneven pattern by dry etching in correspondence with shape of mask formed on a base, control is conducted such that the mask is retroceded or withdrawn following etching, and side wall shape of the uneven pattern results in inclined plane. In order to carry out control in this way, e.g., mask is formed by resin material, and dry etching is carried out by using etching gas including oxygen. As an etching apparatus, it is preferable to use magnetic Neutral Loop Discharge plasma etching apparatus.

### TECHNICAL FIELD

The present invention relates to a method of producing an optical recording medium original plate used for production or manufacturing of various optical discs.

### BACKGROUND ART

In the field of optical recording, realization of higher recording density is being advanced, and it is required to use high resolution photo-resist or electron beam resist, etc. at the process step of producing optical recording medium original plate in correspondence therewith.

These high resolution photo-resist and/or electron beam resist have the feature that side wall takes shape close to 90 degrees after patterning, and are considered to be advantageous to patterning of fine pattern.

Meanwhile, when such resist in which side wall takes shape close to 90 degrees is used to produce an optical recording medium original plate, shape of side wall of pits or grooves also results in shape close to 90 degrees. When this is used to produce stamper to carry out molding of optical disc base (substrate), the influence of the so-called Plowing is feared.

This Plowing is the phenomenon that corner portion is plucked or torn off when molded optical disc base (substrate) is peeled off from the stamper, and greatly injures molded pit shape or groove shape. In optical recording media for high density recording, badness in shape resulting from this Plowing becomes great problem in maintaining performance.

### DISCLOSURE OF THE INVENTION

The present invention has been proposed in view of such conventional circumstances, and an object of the present invention is to provide a method of producing an optical recording medium original plate which can suppress the influence of Plowing, and which can mold pits or grooves at a high density.

To attain this object, a method of producing an optical recording medium original plate according to the present invention is characterized in that, in forming uneven pattern by dry etching in correspondence with shape of mask formed on a base (substrate), control is conducted such that the mask is retroceded or withdrawn following etching and side wall shape of the uneven pattern results in inclined plane.

In the optical recording medium original plate produced in a manner as described above, uneven side wall shape corresponding to pits or grooves becomes inclined plane. As a result, side walls of stamper produced by using this optical recording medium original plate, and pits or grooves of optical disc base (substrate) molded by using this stamper also become inclined plane. Thus, Plowing taking place at the corner portion close to right angle is eliminated.

Still further objects of the present invention and more practical merits obtained by the present invention will become more apparent from the description of the embodiment which will be given below.

### BRIEF DESCRIPTION OF THE DRAWINGS

FIG. 1 is a schematic cross sectional view showing, in process step order, production process for an optical recording medium original plate to which the present invention is applied.

FIG. 2 is a model view showing an example of the configuration of magnetic Neutral Loop Discharge plasma etching apparatus.

FIG. 3 is a schematic cross sectional view of an optical recording medium original plate in which shape of side wall has an angle close to 90 degrees.

### BEST MODE FOR CARRYING OUT THE INVENTION

A method of producing an optical recording medium original plate to which the present invention is applied will now be described in more practical sense with reference to the attached drawings.

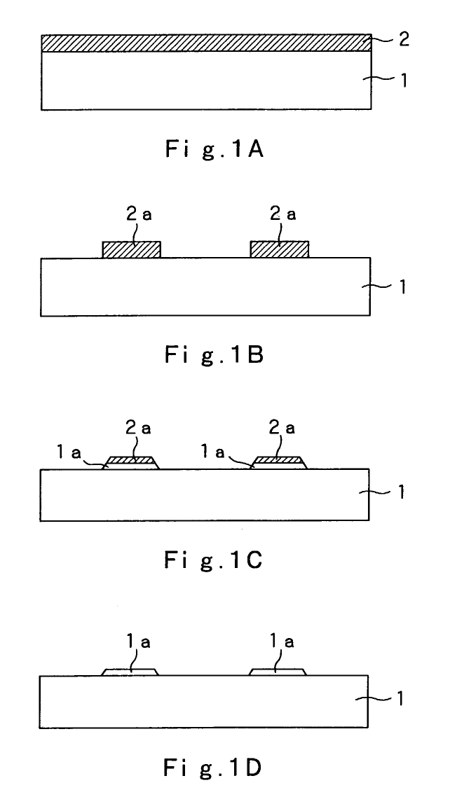

FIGS. 1A and 1D show, in process step order, an original plate producing process in which the present invention is applied to produce an optical recording medium original plate. The process illustrated here includes, as main process steps, four process steps of a formation process step for resist material layer (FIG. 1A), an exposure/development process step for resist material layer (FIG. 1B), a dry etching process step for base (substrate) in which resist material layer is caused to be mask (FIG. 1C), and a process step for peeling/removing resist material layer used as mask (FIG. 1D).

In order to produce an optical recording medium original plate, first, as shown in FIG. 1A, resist material is coated on a base (substrate) 1 to form a resist material layer 2.

For the base (substrate) 1, base of arbitrary material such as Si or quartz, etc. may be used. Its thickness is also arbitrary.

As resist material, resist material in which thermal deformation is small and shape can be maintained even at a temperature close to carbonisation is preferable. In addition, resist material which can cope with realization of high density is preferable. As such resist material, positive photo-resist consisting of novolak resin, etc. and electron beam resist consisting of poly methyl methacrylate material, etc. can be mentioned.

The resist material layer 2 is formed by coating these resist materials on the base (substrate) 1 by using a technique such as spin coat, etc.

Then, as shown in FIG. 1B, exposure/development of the resist material layer 2 are carried out so that pattern corresponding to pit shape or groove shape, etc. is provided. It is to be noted that it is sufficient that exposure/development are carried out in accordance with ordinary technique,but exposure/development is not particularly limited.

As a result, on the base (substrate) 1 which has been exposed/developed, patterned resist material layers 2a remain.

Then, as shown in FIG. 1C, dry etching of the base (substrate) 1 is carried out with the patterned resist material layers 2a being as mask.

At this time, it is important that dry etching is carried out under the condition where retrocession or withdrawal takes place at the resist material layers 2a serving as mask.

By carrying out dry etching under such condition, control is conducted such that shape of side wall results in inclined plane as shown in FIG. 1C. Thus, shapes of projected portions 1a formed on the base 1 are caused to be trapezoidal.

In order to produce retrocession or withdrawal in the resist material layer 2a serving as mask in dry etching, it is sufficient to introduce, e.g., oxygen into etching gas.

Ordinarily, as etching gas for carrying out dry etching of base (substrate) 1 consisting of Si, etching gas of fluorocarbon system such as CF₄, C₂F₆, C₃F₈, etc. is used. In this case, oxygen is mixed into such etching gas. Thus, resist material layer 2a is gradually retroceded or withdrawn with advancement of etching. Following this, side wall shapes of the projected portions 1a formed on the base (substrate) 1 also result in inclined plane.

Alternatively, in the case where oxygen is included as constitutive element of the resist material layer 2a, this may be also utilized. In this case, it is unnecessary to positively introduce oxygen into etching gas.

While arbitrary etching apparatus can be essentially used for the dry etching, particularly magnetic NLD (Neutral Loop Discharge) plasma etching apparatus may be used to introduce oxygen into atmosphere to thereby realize satisfactory inclination shape.

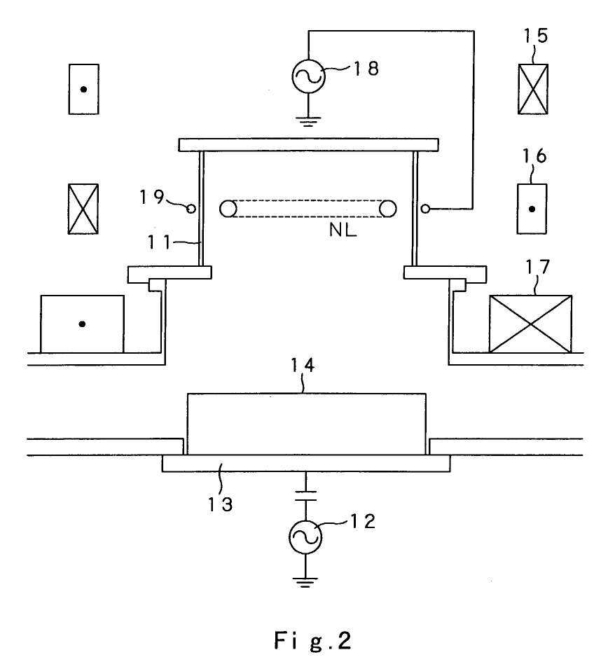

The magnetic NLD plasma etching apparatus has a configuration as shown in FIG. 2, and is a high density plasma etching apparatus using high density plasma source.

When reference is made to the more practical structure thereof, a base (substrate) electrode 13 connected to a high frequency power supply 12 is installed (provided) within a quartz chamber 11 as shown in FIG. 2. Etching is carried out with respect to a base (substrate) 14 mounted on this base electrode 13. In this respect, this apparatus has a configuration similar to ICP (Inductively Coupled Plasma) etching apparatus.

It is to be noted that three coils of a top coil 15, a middle coil 16 and a bottom coil 17 are disposed at the periphery of the quartz chamber 11, and a RF antenna 19 connected to a high frequency power supply 18 is disposed at the position corresponding to the middle coil 16. This apparatus differs from the ICP etching apparatus in this point.

In the magnetic NLD plasma etching apparatus, by action of the three coils (top coil 15, middle coil 16, bottom coil 17) and the RF antenna 19, magnetic Neutral Loop (NL) is produced within the quartz chamber 11.

The magnetic NLD plasma etching apparatus having such a configuration has excellent features.

a. Since diameter of plasma ring can be freely controlled, etching of large area and high uniformity can be carried out.

b. Low pressure and high density plasma is generated by high efficiency discharge by NL, and etching excellent in anisotropic shape can be carried out at a high speed.

c. Excellent reproduction/stability can be realized by temperature control of the side surface.

d. Since NL can be adjusted, time for cleaning or conditioning can be reduced to about one half of ICP, etc.

After completion of the dry etching, as shown in FIG. 1D, resist material layers 2a which have been used as mask are peeled/removed to obtain an optical recording medium original plate having unevenness or irregularity corresponding to pits or grooves.

Explanation will be given below on the basis of more practical experimental results.

Embodiment

Here, magnetic NLD plasma etching apparatus was used to carry out etching of original plate for production of optical disc.

As etching gas, three kinds of gases of C₃F₈, O₂, Ar were used to allow respective flow rates to be 4 SCCM, 2 SCCM, 94 SCCM, and to allow the gas pressure to be 0.27 Pa.

It should be noted that since the magnetic NLD plasma etching apparatus is designed for the purpose of high speed etching, in such cases that an original plate for production of optical disc is formed, it is necessary to lower etching speed.

For this reason, in this embodiment, flow rate of fleon gas (C₃F₈) was caused to be less to introduce Ar gas in order to maintain gas pressure at which discharge can be maintained.

Further, high frequency powers of 1000W and 20W were respectively applied to the RF antenna and the base (substrate) electrode to carry out etching.

As a result, an original plate for production of optical disc in which control is carried out such that shape of side wall results in inclined plane as shown in FIG. 1 was formed.

As the result of the fact that this original plate for production of optical disc was used to produce stamper to mold optical disc base (substrate), the influence of Plowing was hardly recognized.

### COMPARATIVE EXAMPLE

Two kinds of gases of C₃F₈, Ar were used as etching gas to allow respective flow rates to be 4 SCCM and 94 SCCM.

Other etching conditions were caused to be similar to those of the previously described embodiment.

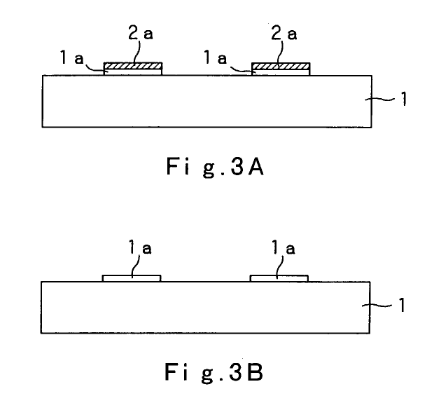

As a result, an original plate for production of optical disc in which shape of side wall is perpendicular as shown in FIGS. 3A and 3B was formed.

As the result of the fact that such original plate for production of optical disc was used to produce stamper to mold optical disc base (substrate), degradation in shape based on the influence of Plowing was recognized in the optical disc base (substrate) obtained.

Industrial Applicability

As described above, in accordance with this invention, it is possible to produce an optical recording medium original plate which can mold pits or grooves at high density without affecting Plowing.

1. A method of producing an optical recording medium original plate, wherein in forming uneven pattern by dry etching in correspondence with shape of mask formed on a base, control is conducted such that the mask is retroceded or withdrawn following etching, and side wall shape of the uneven pattern results in inclined plane.

2. The method of producing optical recording medium original plate as set forth in claim 1, wherein the mask is formed by resin material, and the dry etching is carried out by using etching gas including oxygen.

3. The method of producing optical recording medium original plate as set forth in claim 1, wherein the dry etching is carried out by using a magnetic Neutral Loop Discharge plasma etching apparatus.
